(19) United States
(12) Patent Application Publication
(10) Pub. No.: US 2014/0282204 A1
(43) Pub. Date: Sep. 18, 2014

(54) KEY INPUT METHOD AND APPARATUS USING RANDOM NUMBER IN VIRTUAL KEYBOARD

(71) Applicant: Samsung Electronics Co., Ltd., Gyeonggi-do (KR)

(72) Inventors: Hong-Kyu PARK, Gyeonggi-do (KR); Hye-Won Cho, Daejeon (KR); Jung-Hyun Kim, Gyeonggi-do (KR); Kyung-Soo Lee, Seoul (KR); Il-Ho Lee, Gyeonggi-do (KR)

(73) Assignee: Samsung Electronics Co., Ltd., Gyeonggi-do (KR)

(21) Appl. No.: 14/206,655

(22) Filed: Mar. 12, 2014

(30) Foreign Application Priority Data
Mar. 12, 2013 (KR) 10-2013-0026127

(51) Int. Cl. G06F 3/0488

(52) U.S. Cl. CPC G06F 3/04886
USPC 715/773

(57) ABSTRACT

A method and an apparatus for key input by using a random number in a virtual keyboard in a portable terminal are provided. The method includes sending, to a server, a request for random number generation; receiving a random number generated in response to the request; displaying a virtual keyboard that activates keys corresponding to the received random number; and receiving, through the displayed virtual keyboard, an input of keys.

### PRIORITY

This application claims priority under 35 U.S.C. §119(a) to Korean Application Serial No. 10-2013-0026127, which was filed in the Korean Intellectual Property Office on Mar. 12, 2013, the entire content of which is incorporated herein by reference.

### BACKGROUND OF THE INVENTION

1. Field of the Invention

The present invention relates generally to a portable terminal, such as a method and an apparatus for inputting keys by using a random number in a virtual keyboard, for example.

2. Description of the Related Art

In recent years, high speed internet services have become more common, and next generation TVs into which an Operating System (OS) and a Central Processing Unit (CPU) are loaded have become increasingly popular. As a result, the number of applications available on such devices has increased, and various services are now provided through these devices. In particular, demands for a smart TV, through which users can watch videos while toggling between functions of a cellular phone, a personal computer, and a television are rapidly increasing.

In order to perform operations and functions of various applications that are installed in or downloaded onto a smart TV, functions for inputting characters, numbers, and symbols as well as functions for selection or cancellation have become indispensable. A virtual keyboard input method capable of replacing a function of a computer keyboard is being used to provide functions for input, selection, cancellation, etc.

An information input method using the virtual keyboard is used in conjunction with an input device such as a TV-specific keyboard or a remote control, in which case the virtual keyboard is displayed on a screen of a display device. A user manipulates direction keys, number keys, and function keys of the input device to move a cursor onto the corresponding key of the displayed virtual keyboard and then selects the corresponding key, thereby making it possible to input information. When moving the cursor onto the corresponding key of the virtual keyboard that the user desires to input, the user uses the direction keys of the input device, and when inputting desired information, the user moves the cursor again to select an input button through the direction keys. Even when the user desires to cancel an input of information due to an input error, the user also moves the cursor to select a cancel button of the virtual keyboard through the direction keys, in order to cancel the input of the information.

Moreover, due to accessibility of internet networks and applications, a security problem such as leaking of personal information is emerging as a major issue. Complexity of codes that are generated and used in programs, and guaranteed generation of unpredictable random number combinations are also being required as an essential element in TV applications. Due to this security problem, generation of more complex codes and a user's input for the codes become indispensable. Accordingly, an authentication code and a security code, to which random numbers (which are generated in a manner such that they are unpredictable by an outside source) are applied, are issued to be used as a token in user authentication, program authentication, and interworking authentication. Moreover, when a user accesses a web server while inputting characters corresponding to a stably generated authentication token through a virtual keyboard, the input characters are transmitted in an encoded state, which makes it possible to prevent access of keyboard hacking programs and to secure security of the web server.

One of the most advanced types of virtual keyboards according to the related art is a type in which a plurality of virtual keyboards where language settings are different from each other are prepared and changed according to a user's input or setting, a type in which locations of keys are changed, or a type in which changeability of key areas is applied.

However, according to the related art, a virtual keyboard displayed in a display device always has identical features, and a full virtual keyboard including all characters, numbers, and some special characters in a form similar to that of a real keyboard is provided as a virtual keyboard. Accordingly, a user must perform a manipulation of direction keys a greater number of times than the number that would be necessary when using a physical keyboard in order to seek each target key one-by-one and to move a cursor to the corresponding key on the virtual keyboard. The cursor is ordinarily moved onto a key of the virtual keyboard through a remote control so that a key input time is delayed in the virtual keyboard input method according to the related art. Moreover, when the user repeatedly performs the manipulation of the direction keys to select the target key on the virtual keyboard, user-input error may occur, which greatly increases the need to re-input of selection of the target keys. In particular, in a case of a code used in a system, since an unpredictable random number is generated and applied to the code, the random number corresponds to a combination of somewhat complex character string arrays except for a repeated character string or a sequential numbers. In order to use such a code as described above, a user is indispensably required to navigate amongst a plurality of virtual keyboards and to use special characters, and thus the number of input failures and re-inputs is increased relative to a physical keyboard. Accordingly, there is a need for an alternative input operation that can satisfy both a guarantee of generating a complex code capable of preventing security issues and effectiveness of a method in which a user inputs keys to the virtual keyboard.

### SUMMARY OF THE INVENTION

In order to more easily input a text which a user desires to input in a terminal such as a smart TV for which an input method is inconvenient, it is necessary to generate a virtual keyboard and an intelligent random number for supporting the virtual keyboard such that only characters which may be currently input based on characters having been input by the user may be input. Moreover, there is a need for a solution that guarantees generation of a complex code capable of preventing security issues, and effectiveness of a method in which a user inputs keys to the virtual keyboard. Accordingly, an aspect of the present invention is to address at least the above-described problems and to provide at least the advantages described below.

Accordingly, an aspect of the present invention is to provide an apparatus and a method for inputting keys by using a random number in a virtual keyboard, in which an input keyboard, in which only characters which a user can input are displayed, is dynamically generated so that a user may more conveniently input characters.

In accordance with an aspect of the present invention, a method for key input through a generated virtual keyboard in a portable terminal is provided. The method includes sending, to a server, a request for random number generation; receiving a random number generated in response to the request; displaying a virtual keyboard that activates keys corresponding to the received random number; and receiving, through the displayed virtual keyboard, an input of keys.

In accordance with another aspect of the present invention, a portable terminal in which keys are input through a generated virtual keyboard is provided. The portable terminal includes a transmitter/receiver that transmits, to a server, a request for random number generation, and receives a random number generated in response to the request; a controller that controls displaying of the virtual keyboard in which keys corresponding to the received random number; and a touch screen that displays the virtual keyboard.

In accordance with another aspect of the present invention, a method of generating a random number in a server is provided. The method includes receiving a request for random number generation; determining a random number generation condition in response to the received request, and generating the random number corresponding to the determined random number generation condition; and transmitting the generated random number to a portable terminal.

In accordance with another aspect of the present invention, a server that generates a random number is provided. The server includes a controller that determines a random number generation condition in response to a random number generation request received from a portable terminal; and a random number generating unit that generates the random number corresponding to the determined random number generation condition, wherein, when a request for a significant character string is received from the portable terminal in response to an input of prefix information, the controller controls transmission of the requested significant character string to the portable terminal.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a schematic block diagram illustrating a portable terminal according to an embodiment of the present invention;

FIG. 2 is a block diagram illustrating a virtual keyboard generating system using a random number according to an embodiment of the present invention;

FIG. 3 is a flowchart illustrating a method of inputting keys by generating a virtual keyboard using a random number according to an embodiment of the present invention;

FIG. 4 is a diagram illustrating an example of inputting keys to a virtual keyboard according to an embodiment of the present invention; and

FIG. 5 is a diagram illustrating an example of inputting keys to a virtual keyboard that has been generated through a random number according to an embodiment of the present invention.

### DETAILED DESCRIPTION OF EMBODIMENTS OF THE PRESENT INVENTION

Although various modifications may be made to the present invention, and the present invention may be embodied in many different forms, embodiments the present invention are described in detail as follows with reference to the accompanying drawings. However, it should be understood that there is no intent to limit the present invention to the particular forms described. To the contrary, embodiments of the present invention include all modifications, equivalents, and alternatives falling within the scope of the invention.

Although the terms including an ordinal number such as first, second, etc. can be used for describing various elements, the elements are not restricted by the terms. Herein, such terms are merely used to distinguish one element from another element. For example, a first element could be termed a second element, and similarly, a second element could be also termed a first element without departing from the scope of the present invention. As used herein, the term “and/or” includes any and all combinations of one or more of the associated listed items.

The terms used in this application are merely used for the purpose of describing particular embodiments and are not intended to be limiting of the invention. As used herein, the singular forms are intended to include the plural forms as well, unless the context clearly indicates otherwise. Terms “includes” and/or “including”, when used in this specification, specify the presence of stated features, integers, steps, operations, elements, components, and/or groups thereof but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. Terms, such as those defined in commonly used dictionaries, are to be interpreted as having a meaning that is consistent with their meaning in the context of the relevant art, but not in an idealized or overly formal sense, unless expressly so defined herein.

Hereinafter, an operation principle of embodiments of the present invention is described in detail with reference to the accompanying drawings. Below, in describing the present invention, detailed descriptions related to well-known functions or configurations may be omitted when they may unnecessarily obscure the subject matter of the present invention. The terms described below are terms defined in consideration of the functions in the present invention, and may be different according to users, intentions of the users, or customs. Thus, the terms should be defined based on the contents over the whole present specification.

First, certain terms to be used with respect to the present invention are defined as follows:

A portable terminal is a mobile terminal which can be carried, and through which data transmission/reception, and voice and video calls can be made. One or more touch screens may be installed in the portable terminal. The portable terminal includes a smart phone, a tablet Personal Computer (PC), a three-dimensional (3D) TV, a smart TV, a Light-Emitting Diode (LED) TV, and a Liquid Crystal Display (LCD) TV. In addition to the above-listed terminals, portable terminals may also include terminals capable of communicating with peripheral devices or other remote terminals.

An input unit includes at least one of a finger, an electronic pen, and a stylus pen that may provide a command or an input to the portable terminal in a contact state on a touch screen or in a non-contact state such as a hovering.

An object (i.e., a thing that is displayed or may be displayed on the touch screen of the portable terminal) includes at least one of a document, a widget, a photograph, a moving image, an e-mail, a writing paper, a Short Message Service (SMS) message, and a Multimedia Message Service (MMS) message, and may be executed, deleted, cancelled, stored, and modified by the input unit. The object may also be any of a shortcut icon, a thumbnail image, and a folder that stores at least one object in the portable terminal.

A shortcut icon is displayed on the touch screen of the portable terminal for rapid execution of applications, and a telephone call, a contact address, and a menu that are basically provided in the portable terminal, and executes the corresponding application when a command or an input for executing the shortcut icon is input.

FIG. 1 is a schematic block diagram illustrating a portable terminal according to an embodiment of the present invention.

Referring to FIG. 1, a portable terminal 100 may be connected with an external device (not shown) by using at least one of a mobile communication module 120, a sub-communication module 130, a connector 165, and an earphone connecting jack 167. The external device may include various devices, such as an earphone, an external speaker, a Universal Serial Bus (USB) memory, a charger, a Cradle/Dock, a Digital Multimedia Broadcasting (DMB) antenna, a mobile payment related device, a health care device (e.g., a blood sugar measuring device), a game machine, and a vehicle navigation device, which may be detachably connected to the portable terminal 100 in a wired manner. Moreover, the external device may include a Bluetooth communication device, a Near Field Communication (NFC) device and a Wi-Fi Direct communication device that may be connected to the portable terminal 100 in a wireless manner, and a wireless Access Point (AP). The portable terminal may be connected to other devices such as a cell phone, a smart phone, a tablet PC, a desktop PC, and a server by using a wired or wireless manner.

Referring to FIG. 1, the portable terminal 100 may include at least one touch screen 190, and at least one touch screen controller 195. Moreover, the portable terminal 100 may include a controller 110, a mobile communication module 120, a sub-range communication module 130, a multimedia module 140, a camera module 150, a Global Positioning System (GPS) module 157, an input/output module 160, a sensor module 170, a storage unit 175, and a power supply unit 180.

The sub-range communication module 130 may include at least one of a wireless Local Area Network (LAN) module 131 and a near field communication module 132, and the multimedia module 140 may include at least one of a broadcasting communication module 141, an audio playback module 142, and a video playback module 143. The camera module 150 may include at least one of a first camera 151 and a second camera 152. Moreover, the camera module 150 of the portable terminal 100 may include at least one of a body tube 155 for performing zoom in/out of the first and the second cameras 151 and 152, a motor 154 controlling a movement of the body tube 155 for performing zoom in/out of the body tube 155, and a flash 153 providing a light source for photography. The input/output module 160 may include at least one of a button 161, a microphone 162, a speaker 163, a vibration motor 164, a connector 165, and a keypad 166.

The controller 110 may include a Central Processing Unit (CPU) 111, a Read-Only Memory (ROM) 112 in which control programs for control of the portable terminal 100 may be stored, and a Random Access Memory (RAM) 113 which stores signals or data input from the outside of the portable terminal 100, or may be used as a memory area for operations performed in the portable terminal 100. The CPU 111 may include a single core, a dual core, a triple core, or a quad core processor, for example. The CPU 111, the ROM 112, and the RAM 113 may be connected with each other through an internal bus.

The controller 110 may control the mobile communication module 120, the sub-range communication module 130, the multimedia module 140, the camera module 150, the GPS module 157, the input/output module 160, the sensor module 170, the storage unit 175, the power supply unit 180, the touch screen 190, and the touch screen controller 195.

Moreover, when a plurality of objects are displayed on the touch screen 190, the controller 110 may determine whether a hovering event is recognized as a touchable input unit 168, such as when an electronic pen closely approaches any one of the objects, and may determine whether there is a touch of the input unit 168 on the touch screen 190. Moreover, the controller 110 may detect an interval between the portable terminal 100 and the input unit 168, and determine a hovering input according to the interval. More specifically, the controller 110 may detect a hovering input of the input unit 168 hovering over the touch screen 190, or a touch input generated by touching the input unit 168 on the touch screen 190.

The controller 110 may monitor a movement of the input unit 168 until a time when the input unit 168 is continuously completely moved on the touch screen 190 (i.e., a time when a handwriting or a picture is completed), and then generate and transmit a control signal to the input unit 168.

The mobile communication module 120 enables the portable terminal 100 to be connected with the external device through mobile communication by using at least one antenna (not shown) under the control of the controller 110. The mobile communication module 120 transmits/receives wireless signals for a voice call, a video call, a Short Message Service (SMS), or a Multimedia Message Service (MMS) to/from a cell phone (not shown), a smart phone (not shown), a tablet PC (not shown), or other devices (not shown), having phone numbers which are input to the portable terminal 100.

The sub-range communication module 130 may include at least one of the wireless LAN module 131 and the near field communication module 132. For example, the sub-range communication module 130 may include only the wireless LAN module 131, or only the near field communication module 132. Alternatively, the sub-communication module 130 may include both the wireless LAN module 131 and the near field communication module 132.

The wireless LAN module 131 may be connected to the internet, at a place where a wireless Access Point (AP) (not shown) is installed, under the control of the controller 110. The wireless LAN module 131 supports a wireless LAN protocol IEEE802.11x of the Institute of Electrical and Electronics Engineers (IEEE). The near field communication module 132 may wirelessly perform near field communication between the portable terminal 100 and an image forming device (not shown) under the control of the controller 110. The near field communication method may include Bluetooth, InfraRed Data Association (IrDA), Wi-Fi direct communication, and Near Field Communication (NFC).

The controller 110 may transmit a control signal in response to a haptic pattern to the input unit through at least one of the wireless LAN module 131 and the near field communication module 132.

The portable terminal 100 may include at least one of the mobile communication module 120, the wireless LAN module 131, and the near field communication module 132. For example, the portable terminal 100 may include combinations of the mobile communication module 120, the wireless LAN module 131, and the near field communication module 132. According to embodiments of the present invention, at least one of the mobile communication module 120, the wireless LAN module 131, and near field communication module 132 is referred to as a transmitter/receiver. However, other transmitter/receivers may be used in accordance with embodiments of the present invention.

The multimedia module 140 may include the broadcasting communication module 141, the audio playback module 142, or the video play module 143. The broadcasting communication module 141 may receive a broadcasting signal (for example, a TV broadcasting signal, a radio broadcasting signal, or a data broadcasting signal), and broadcasting additional information (for example, Electric Program Guide (EPG), or Electric Service Guide (ESG)), which have been transmitted from a broadcasting station through a broadcasting communication antenna, under the control of the controller 110. The audio play module 142 may play digital audio files (for example, files with an extension such as mp3, wma, ogg, and wav), which are stored or received under the control of the controller 110. The video play module 143 plays digital video files (for example, files with an extension such as mpeg, mpg, mp4, avi, mov, and mkv) that are stored or received under the control of the controller 110. The video play module 143 may play the digital audio files.

The multimedia module 140 may include the audio play module 142, and the video play module 143, without including the broadcasting communication module 141. Moreover, the audio play module 142 or the video play module 143 of the multimedia module 140 may be included in the controller 110.

The camera module 150 may include at least one of the first camera 151 and the second camera 152 for photographing still images and videos under the control of the controller 110. Moreover, the camera module 150 may include at least one of the body tube 155 performing zoom in/out for photography of a subject, the motor 154 controlling a movement of the body tube 155, and the flash 153 providing a subsidiary light source necessary for photographing the subject. The first camera 151 may be disposed on a front surface of the portable terminal 100, and the second camera 152 may be disposed on a rear surface of the portable terminal 100. As an alternative, the first camera 151 and the second camera 152 may be disposed adjacent to each other (for example, an interval between the first camera 151 and the second camera 152 may be between a distance of 1 cm and 8 cm) to photograph three-dimensional still images or three-dimensional moving images.

Moreover, the first and the second cameras 151 and 152 may include a lens system and an image sensor. The first and second cameras 151 and 152 may convert an optical signal input (or photographed) through the lens system into an electric image signal, and output the electric image signal to the controller 110. A user may photograph a moving image or a still image through the first and the second cameras 151 and 152.

The GPS module 157 may receive electric waves from a plurality of GPS satellites (not shown) in Earth orbit, and may calculate a location of the portable terminal 100 by using the arrival times of the electric waves from the GPS satellites (not shown) to the portable terminal 100.

The input/output module 160 may include at least one of a plurality of buttons 161, the microphone 162, the speaker 163, the vibration motor 164, the connector 165, the keypad 166, the earphone connecting jack 167, and the input unit 168. The input/output module according to embodiments of the present invention is not limited thereto, and furthermore the input/output module may comprise cursor control at least one of a mouse, a track ball, a joystick, and cursor direction keys. The controller 110 may also control a movement of a cursor be provided by at least one of the mouse, the track ball, the joystick and cursor direction keys on the touch screen 190.

The buttons 161 may be formed on a front surface, a side surface, or a rear surface of a housing of the portable terminal 100, and may include at least one of a power/lock button (not shown), a volume button (not shown), a menu button, a home button, a back button, and a search button.

The microphone 162 receives voices or sounds to generate electric signals under the control of the controller 110.

The speaker 163 may output sounds corresponding to various signals (for example, a wireless signal, a broadcasting signal, a digital audio file, a digital video file, or photography) of the mobile communication module 120, the sub-communication module 130, the multimedia module 140, or the camera module 150, to the outside of the portable terminal 100 under the control of the controller 110. Moreover, the speaker 163 may output a sound corresponding to a control signal transferred to the input unit 168 through the near field communication module 132. The sound corresponding to the control signal includes a sound in response to activation of a vibration element 520 of the input unit 168, a sound whose magnitude is varied depending on vibration intensity, and a sound in response to deactivation of the vibration element 520. Volume of the sound may be controlled in response to the vibration intensity of the vibration element 520 of the input unit 168, or the sound may be output through the speaker 163 of the portable terminal 100 and/or a speaker 560 which may be provided to the input unit 168, at the same time as the activation of the vibration element 520, or at a predetermined time interval (for example, 10 ms) before or after the activation of the vibration element 520. Moreover, the output of the sound may be stopped at the same time as the deactivation of the vibration element 520, or at a predetermined time interval (for example, 10 ms) before or after the deactivation of the vibration element 520. The speaker 163 may output sounds (for example, a button operation tone corresponding to a telephone call, or a call connection tone) corresponding to functions that the portable terminal 100 performs. One or more speakers 163 may be formed at an appropriate location or locations of the housing of the portable terminal 100 for outputting sound.

The vibration motor 164 may convert an electric signal into a mechanical vibration under the control of the controller 110. For example, when receiving a voice call from another device (not shown), the portable terminal 100, when operating in a vibration mode, operates the vibration motor 164. One or more vibration motors 164 may be formed in the housing of the portable terminal 100. The vibration motor 164 may operate in response to a touch of a user on the touch screen 190, and a continuous movement of a touch on the touch screen 190, for example.

The connector 165 may be used as an interface for connecting the portable terminal 100 with the external device (not shown) or a power source (not shown). The portable terminal 100 may transmit data stored in the storage unit 175 of the portable terminal 100 to the external device (not shown), or may receive data from the external device (not shown) through a wired cable connected to the connector 165 under the control of the controller 110. Moreover, the portable terminal 100 may receive an electric power from the power source (not shown) through the wired cable connected to the connector 165, or may charge a battery (not shown) by using the power source.

The keypad 166 may receive a key input from the user for the control of the portable terminal 100. The keypad 166 includes a physical keypad (not shown) formed in the portable terminal 100, or a virtual keypad (not shown) displayed on the touch screen 190. The physical keypad (not shown) formed in the portable terminal 100 may be excluded from the portable terminal 100 according to the performance or the structure of the portable terminal 100.

An earphone may be inserted into the earphone connecting jack 167 to be connected to the portable terminal 100. The input unit 168 may be inserted into and kept in an interior of the portable terminal 100, and may be withdrawn or detached from the portable terminal 100 at a time of use. An attaching/detaching recognition switch 169 operating in correspondence to mounting and detaching of the input unit 168 may be installed at an area in the portable terminal 100 into which the input unit 168 is inserted, making it possible to provide a signal corresponding to the mounting and the detaching of the input unit 168 to the controller 110. The attaching/detaching recognition switch 169 is installed at the area in the portable terminal 100 into which the input unit 168 is inserted to directly or indirectly contacts the input unit 168 when the input unit 168 is mounted. Accordingly, the attaching/detaching recognition switch 169 generates and provides a signal corresponding to the mounting or the detaching of the input unit 168 to the controller 110 based on direct or indirect contact with the input unit 168.

The sensor module 170 includes at least one sensor for detecting a state of the portable terminal 100. For example, the sensor module 170 may include a proximity sensor for detecting a user's proximity to the portable terminal 100, an illumination sensor (not shown) for detecting a quantity of light around the portable terminal 100, a motion sensor (not shown) for detecting motion (e.g., a rotation of the portable terminal 100, and acceleration or vibration applied to the portable terminal 100) of the portable terminal 100, a geo-magnetic sensor for detecting a point of a compass by using Earth's magnetic field, a gravity sensor for detecting an action direction of gravity, and an altimeter for detecting an altitude by measuring atmospheric pressure. At least one sensor may detect the state, and generate and transmit a signal corresponding to the detection to the controller 110. The at least one sensor of the sensor module 170 may be added or omitted according to the performance of the portable terminal 100.

The storage unit 175 may store the signal or the data, which is input and output to correspond to operations of the mobile communication module 120, the sub-communication module 130, the multimedia module 140, the camera module 150, the GPS module 157, the input/output module 160, the sensor module 170, and the touch screen 190, under the control of the controller 110. The storage unit 175 may store control programs for the control of the portable terminal 100 or the controller 110, or applications.

The term referred to as “storage unit” is used with the meaning including the storage unit 175, the ROM 112 and the RAM 113 in the controller 110, or a memory card (not shown) (for example, a Secure Digital (SD) card, and a memory stick), which is mounted to the portable terminal 100. The storage unit may include a non-volatile memory, a volatile memory, a Hard Disk Drive (HDD), or a Solid State Drive (SSD).

The storage unit 175 may store a navigation, a video call, a game, images for providing applications with various functions such as a time based alarm application and a Graphic User Interface (GUI) related to the applications to a user, user information, a document, databases or data related to a method of processing a touch input, background images (a menu screen and a standby screen) or operating programs necessary for driving the portable terminal 100, and images having been photographed through the camera module 150. The storage unit 175 is a machine (for example, a computer) readable medium, and the term referred to as a machine readable medium may be defined as a medium providing data to the machine such that the machine may perform a specific function. The machine readable medium may be a storage medium. The storage unit 175 may include a non-volatile memory and a volatile memory. All such mediums include some tangible form, such that commands transferred through the mediums may be detected by a physical mechanism reading the commands into the machine.

The machine readable medium according to embodiments of the present invention is not limited thereto, and includes at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a FLASH-EPROM.

The power supply unit 180 may supply an electric power to one or more batteries (not shown) disposed in the housing of the portable terminal 100 under the control of the controller 110. The one or more batteries supply the electric power to the portable terminal 100. Moreover, the power supply unit 180 may supply the electric power, which is input from an external power source (not shown) through the wired cable connected with the connector 165, to the portable terminal 100. Furthermore, the power supply unit 180 may also supply the electric power, which is wirelessly input from the external power source through a wireless charging technology, to the portable terminal 100.

The portable terminal 100 may include at least one touch screen providing user interfaces corresponding to various services (e.g., telephone calls, data transmission, broadcasting, and photography) to the user. The touch screen 190 may transmit an analog signal corresponding to at least one touch which is input to the user interface, to the touch screen controller 195. In this way, the portable terminal 100 may include a plurality of touch screens, and each of the touch screens may include a touch screen controller receiving an analog signal corresponding to a touch. The touch screens may be connected to a plurality of housings through a hinge connection, respectively, or the plurality of the touch screens may be located in one housing without the hinge connection. As described above, the portable terminal 100 according to the present invention may include at least one touch screen. Hereinafter, for convenience of description, an example in which the portable terminal includes a single touch screen is described.

The touch screen 190 may receive the at least one touch through a user's body (for example, fingers including a thumb) or a touchable input unit (for example, a stylus pen and an electronic pen). Moreover, when the touch is input through the stylus pen or the electronic pen, the touch screen 190 includes a pen recognition panel 191 recognizing the touch input, and the pen recognition panel 191 may determine a distance between the pen and the touch screen 190 through a magnetic field. Moreover, the touch screen 190 may receive a continuous movement of the at least one touch. The touch screen 190 may transmit an analog signal corresponding to the continuous movement of the input touch to the touch screen controller 195.

In addition, in the present invention, the touch is not limited to the contact between the touch screen 190 and the user's body or the touchable input unit, and the touch may include non-contact state (e.g., an interval of about 5 mm) by which the touch can be detected without contact between the touch screen 190 and the user's body or the touchable input unit). In the touch screen 190, the detectable interval may be changed according to a performance or a structure of the portable terminal 100, and in particular, in order to separately detect a touch event through contact with the user's body or the touchable input unit and an input event (e.g., a hovering event) in a non-contact state, the touch screen 190 is configured such that values (e.g., including an analog value such as a voltage value or a current value) detected by the touch event and the hovering event may be output differently from each other. Furthermore, preferably, the touch screen 190 outputs the detected values (e.g., current values) differently according to a distance between a space where the hovering event is generated and the touch screen 190.

For example, the touch screen 190 may be realized in a resistive manner, a capacity manner, an infrared manner, or an acoustic wave manner, for example.

Moreover, the touch screen 190 may include at least two touch screen panels capable of detecting a touch or close access through a user's body and a touchable input unit to sequentially or simultaneously receive an input through the user's body or the touchable input unit. The at least two touch screen panels may provide output values different from each other to the touch screen controller, and the touch screen controller may recognize different values input from the at least two touch screen panels to identify whether the input from the touch screen 190 corresponds to the input through the user's body or the touchable input unit.

More specifically, the touch screen 190 may be formed with a structure in which a panel detecting an input through the fingers or the input unit 168 by using a change in an induced electromotive force, and a panel detecting contact, through the fingers or the input unit 168, with the touch screen 190 are attached to each other, or are spaced slightly apart from each other and stacked on one another. The touch screen 190 includes a plurality of pixels, and displays an image through the pixels. The touch screen 190 may use a Liquid Crystal Display (LCD), an Organic Light Emitting Diode (OLED), or a Light Emitting Diode (LED).

Moreover, the touch screen 190 includes a plurality of sensors detecting a location of the fingers or the input unit 168 when the fingers or the input unit 168 contacts a surface of the touch screen 190, or is spaced apart from the touch screen at a predetermined distance. The plurality of sensors may be formed with a coil structure, and in a sensor layer formed of the plurality of sensors, the sensors are arranged in a predetermined pattern and form a plurality of electrode lines. In the structure as described above, when the fingers or the input unit 168 makes contact with the touch screen 190, a waveform modified detection signal is generated on account of an electrostatic capacity between the sensor layer and the input unit, in which case the touch screen 190 transmits the generated detection signal to the controller 110. A distance between the input unit 168 and the touch screen 190 may be determined through intensity of a magnetic field generated by a coil 430. Hereinafter, a process of setting a vibration intensity according to an embodiment of the present invention is described.

The touch screen controller 195 may convert an analog signal received from the touch screen 190 to a digital signal (e.g., X and Y coordinates), and then transmit the digital signal to the controller 110. The controller 110 may control the touch screen 190 by using the digital signal received from the touch screen controller 195. For example, the controller 110 may allow a shortcut icon (not shown) displayed on the touch screen 190 or an object to be selected, or may execute the shortcut icon in response to a touch event or a hovering event. Moreover, the touch screen controller 195 may also be included in the controller 110.

In addition, the touch screen controller 195 may detect a value (for example, a current value) output through the touch screen 190 to identify a distance between a space where a hovering event occurs and the touch screen, thereby enabling conversion of the identified distance value into a digital signal (for example, Z-coordinate), in order to provide the digital signal to the controller 110.

FIG. 2 is a block diagram illustrating a virtual keyboard generating system using a random number according to an embodiment of the present invention.

As shown in FIG. 2, the virtual keyboard generating system using the random number according to an embodiment of the present invention includes a portable terminal 210 that displays a virtual keyboard and receives a random number through the displayed virtual keyboard, and further includes a server 250 that generates a random number in response to a request of the portable terminal 210 and transmits the random number to the portable terminal.

The portable terminal 210 includes a display unit 211 that performs the functions of a touch screen and a virtual keyboard 220, which includes a screen unit 221 that displays the virtual keyboard on a screen, and an input unit 222 that receives arbitrary key inputs through the displayed keyboard. The portable terminal 210 further includes a random number managing unit 230, which includes a random number requesting unit 231 that requests a random number and a random number receiving unit 232 that receives the random number in response to the request.

The server 250 includes a controller 251, which defines a random number generation condition in response to a random number generation request having been received from the portable terminal 210, and further includes a random number generating unit 252, which generates a random number in response to the random number generation condition.

Hereinafter, the virtual keyboard generating system using the random number according to an embodiment of the present invention is described in detail with reference to FIG. 2.

The display unit 211 shown in FIG. 2 may be applied to the touch screen 190 shown in FIG. 1, and the virtual keyboard 220 may be displayed on the touch screen 190 under the control of the controller 110. Furthermore, the random number managing unit 230 may be executed in the controller 110 shown in FIG. 1.

The random number requesting unit 231 of the random number managing unit 230 of the portable terminal 210, requests random number generation from the server 250 that generates the random number. The request is transmitted to the server 250 together with information necessary for the random number generation. The random number receiving unit 232 of the random number managing unit 230 receives the generated random number from the server 250, and keys corresponding to the received random number are activated in the virtual keyboard and are displayed in the display unit 211. The virtual keyboard 220 corresponds to a tool for receiving key inputs from a user in a device serving as a client such as a smart phone, a smart TV, an Internet Protocol (IP) TV, and a PC. The virtual keyboard 220 includes the input unit 222 through which characters are input by a user, and the screen unit 221 which sorts out only characters which can be input based on a character string which a user has input so far and shows or activates the sorted characters to provide keys of a keyboard such as a virtual keyboard to the user. Moreover, when prefix information of the random number having been received from the server is input in a state where the virtual keyboard is displayed, the portable terminal 210 requests a significant character string corresponding to the random number from the server. When the significant character string is received in response to the request, the portable terminal 210 activates and display keys corresponding to the received significant character string in the virtual keyboard. Such a display as described above may also imply displaying the virtual keyboard that activates the keys corresponding to keys of the received random number in response to an input of the prefix information of the received random number. Furthermore, the virtual keyboard activates keys corresponding to a significant character string in response to an input of prefix information included in the received random number, or may activate keys corresponding to the significant character string included in the received random number. The significant character string corresponds to a set of at least one character that can be input based on the characters that have been input so far through the displayed virtual keyboard.

The server 250 receives the random number generation request from the random number requesting unit 231 of the portable terminal, and generates and transmits the random number to the random number receiving unit 232 of the portable terminal 210. In response to the request, the controller 251 of the server 250 defines and determines the random number generation condition, and then transmits related information to the random number generating unit 252. The random number generation condition may be defined as at least one of a character group used in a random number, a size of the character group, and a length of a random number. The random number generating unit 252 generates a random number according to the random number generation condition transferred from the controller 251, and transmits the generated random number to the random number receiving unit 232 of the portable terminal 210. The server 250 is connected with the portable terminal 210 through a wired/wireless network 240, and may correspond to a set-top box located adjacent to the portable terminal 210, when the portable terminal 210 corresponds to a smart TV or an IPTV.

As explained above, the server 250 determines the random number generation condition in response to the random number generation request having been received from the portable terminal 210, generates a random number corresponding to the determined random number generation condition, and transmits the generated random number to the portable terminal. Moreover, when receiving a request for a significant character string from the portable terminal in response to an input of prefix information, the server 250 transmits the requested significant character string to the portable terminal. For example, the significant character string may define a set of at least one character that can be input based on the characters having been input so far through the virtual keyboard displayed in the portable terminal, and corresponds to keys activated in the virtual keyboard.

FIG. 3 is a flowchart illustrating a method of inputting keys by generating a virtual keyboard using a random number according to an embodiment of the present invention, FIG. 4 is a diagram illustrating an example of inputting keys to a virtual keyboard according to an embodiment of the present invention, and FIG. 5 is a diagram illustrating an example of inputting keys to a virtual keyboard that has been generated through a random number.

Hereinafter, the method of inputting the keys by generating the virtual keyboard using the random number according to the embodiment of the present invention is described in detail as follows with reference to FIGS. 3 to 5.

Referring to FIG. 3, a random number generation is requested from a server, in step S310. A random number requesting unit 231 of a portable terminal 210 transmits the request, which includes information necessary for random number generation, to the server 250 to request the random number generation. According to an embodiment of the present invention, the information necessary for the random number generation may have an influence on a singularity of a random number, and the portable terminal can make an agreement with the server to generate the random number. For example, when being used as an invitation code of chat rooms, the information necessary for the random number generation includes the number of the chat rooms being currently generated.

A random number generated in response to the request in process 5310 is received, in step S312. The portable terminal 210 requests the random number generation from the server, and the server 250 generates the random number in response to the request and transmits the generated random number to the portable terminal 210. The server 250 includes a controller 251 that determines a random number generation condition for generating the random number, and a random number generating unit 252 that generates the random number under the determined random number generation condition. The generated random number may be largely formed of two fields. One field includes prefix information, and the other field includes a significant character string. An example of the random number is provided in the following Table 1.

TABLE 1

| Prefix | Significant character string |
|---|---|
| 10 | R87J047 |

As shown in Table 1, the prefix information corresponds to a single key for defining the character string included in the significant character string, and the significant character string corresponds to key values that will be activated in the virtual keyboard. When the prefix information (e.g., 10) is input, the virtual keyboard activates only keys corresponding to the significant character string (e.g., R87J047), and deactivates keys that do not correspond to the significant character string, so that the portable terminal having received the random number is able to more rapidly receive key inputs from a user. The significant character string of the generated random number may be randomly generated based on the random number generation condition. The server stores the generated random number.

A virtual keyboard activating keys applied to the received random number is displayed, in step S314. When the random number generated by the server 250 is received, the portable terminal analyzes the received random number to display the virtual keyboard through which a user inputs keys. The displayed virtual keyboard may be a common keyboard connected to a computer, and may be a keyboard that can be applied to a smart TV or an IPTV. The virtual keyboard is displayed in a display unit 211 of the portable terminal 210. When the portable terminal 210 corresponds to a television such as a smart TV or an IPTV, a unit for inputting keys to the displayed virtual keyboard may be a remote control.

FIG. 4 is a diagram illustrating an example of inputting keys to a virtual keyboard according to an embodiment of the present invention. Referring to FIG. 4, a television 410 corresponding to a portable terminal, and a remote control 420 inputting keys to the television 410 are shown. When a random number is received from a server 250, the television 410 analyzes the received random number, and displays a virtual keyboard 411. The television 410 may display at least one of prefix information and a significant character string of the received random number in addition to the virtual keyboard. The prefix information and the significant character string may be input to the displayed virtual keyboard 411 through the remote control 420.

Keys are input through the virtual keyboard having been displayed in process S314, in step S316. When the random number generated by the server 250 is received, the portable terminal analyzes the received random number to display the virtual keyboard through which a user inputs the keys. At this time, all the keys displayed in the virtual keyboard may be activated or deactivated. The activation is performed to activate the keys such that key selection with respect to the activated keys may be input, and the deactivation is performed to preclude the deactivated keys from being selected. Moreover, the displayed virtual keyboard may analyze prefix information included in the received random number to activate only the character string corresponding to a key of the analyzed prefix information, and when the prefix information is normally input, may activate the keys corresponding to the significant character string included in the received random number.

FIG. 5 is a diagram illustrating an example of inputting keys to a virtual keyboard that have been generated through a random number according to an embodiment of the present invention.

Referring to FIG. 5, a television 510 analyzes the received random number and displays a virtual keyboard 511 that includes activated keys corresponding to a significant character string. In the virtual keyboard 511, a remote control 520 may be used in order to select the keys corresponding to the significant character string, or a user may directly select the corresponding keys of the virtual keyboard by using fingers. In the virtual keyboard 511, keys corresponding to numbers 4, 7, 8, and 0 and characters R and J are activated. The activated keys of the virtual keyboard 511 may be input or selected though a button 522 and a direction button 523 of the remote control 520. In this way, when the significant character string is normally input, a user of the television may share various pieces of information such as program sharing and an invitation to a chat room with other users that have input a significant character string.

Embodiments of the present invention can be realized in a form of hardware, software, or a combination thereof. The software can be stored in, for example, irrespective of being erasable or rewritable, a volatile storage device, a non-volatile storage device such as a Read-Only Memory (ROM), a memory such as a Random Access Memory (RAM), a memory chip device, and an integrated circuit, an optically or magnetically recordable and machine (e.g., a computer) readable storage medium such as a Compact Disc (CD), a Digital Versatile Disc (DVD), a magnetic disk, and a magnetic tape. A memory that can be included in the portable terminal may include any machine readable storage medium that is suitable for storing a program or programs including instructions by which the embodiments of the present invention are realized. Accordingly, embodiments of the present invention may include a program that includes a code for realizing a device and a method described in arbitrary claims of the present specification, and a machine readable storage medium storing the program. Moreover, such a program as described above can be electronically transferred through an arbitrary medium such as a communication signal transferred through cable or wireless connection, and the present invention properly includes the things equivalent to that.

Moreover, a portable terminal according to embodiments of the present invention can receive a program from a program providing device that is connected thereto in a wired or wireless manner, and store the received program. The program providing device may include a program including instructions by which a method for key input through a generated virtual keyboard in a portable terminal is performed, a memory for storing information necessary for the method for key input through the generated virtual keyboard, a communication unit for performing wired or wireless communication with the portable terminal, and a controller for transmitting the corresponding program to a host device in response to a request of the portable terminal or automatically.

Meanwhile, although specific embodiments of the present invention are described herein, various modifications may be performed without departing from the scope of the present invention. Accordingly, the scope of the present invention should is not limited to the described embodiments, but is defined by the accompanying claims and the equivalents thereof.

What is claimed is:

1. A method for performing key input through a generated virtual keyboard in a portable terminal, the method comprising:
sending, to a server, a request for random number generation;
receiving a random number generated in response to the request;
displaying a virtual keyboard that activates keys corresponding to the received random number; and
receiving, through the displayed virtual keyboard, an input of keys.

2. The method of claim 1, further comprising:
requesting, when prefix information of the generated random number is input in a state where the virtual keyboard is displayed, a significant character string corresponding to the generated random number from the server.

3. The method of claim 2, further comprising:
activating and displaying, when the significant character string is received in response to the request, keys corresponding to the received significant character string in the virtual keyboard.

4. The method of claim 1, wherein displaying the virtual keyboard comprises:
displaying, in response to an input of prefix information of the received random number, the virtual keyboard, in which the keys corresponding to keys of the received random number are activated.

5. The method of claim 1, wherein the generated random number is divided into a prefix field and a character string field, and wherein the generated number comprises a significant character string, a size of the significant character string, and a length of the generated random number.

6. The method of claim 5, wherein the significant character string comprises a set of at least one character that can be input based on characters having been input so far through the displayed virtual keyboard.

7. The method of claim 1, wherein the virtual keyboard activates keys corresponding to a significant character string in response to an input of prefix information included in the received random number, or activates keys corresponding to a significant character string included in the received random number.

8. A portable terminal in which keys are input through a generated virtual keyboard, the portable terminal comprising:
a transmitter/receiver that transmits, to a server, a request for random number generation, and receives a random number generated in response to the request;
a controller that controls displaying of the virtual keyboard that activates keys corresponding to the received random number; and
a touch screen that displays the virtual keyboard.

9. The portable terminal of claim 8, wherein the controller requests a significant character string corresponding to the generated random number from the server when prefix information of the generated random number is input in a state where the virtual keyboard is displayed.

10. The portable terminal of claim 9, wherein, when the significant character string is input in response to the request, the controller activates keys corresponding to the received significant character string in the virtual keyboard.

11. The portable terminal of claim 8, wherein the controller generates, in response to an input of a prefix significant character string of the received random number, the virtual keyboard that activates the keys corresponding to keys of the received random number.

12. The portable terminal of claim 8, wherein the controller generates the virtual keyboard that activates keys corresponding to a significant character string in response to an input of prefix information included in the received random number, or the virtual keyboard that activates keys corresponding to a significant character string included in the received random number.

13. A method of generating a random number in a server, the method comprising:
receiving a request for random number generation;
determining a random number generation condition in response to the received request, and generating the random number corresponding to the determined random number generation condition; and
transmitting the generated random number to a portable terminal.

14. The method of claim 13, further comprising:
transmitting, when a request for a significant character string is received from the portable terminal in response to an input of a prefix information, the requested significant character string to the portable terminal.

15. The method of claim 13, wherein the generated random number is divided into a prefix field and a character string field, and wherein the generated random number comprises a significant character string, a size of the significant character string, and a length of the generated random number.

16. The method of claim 15, wherein the significant character string comprises a set of at least one character that can be input based on characters having been input so far through the virtual keyboard displayed in the portable terminal.

17. The method of claim 16, wherein the significant character string corresponds to keys activated in the virtual keyboard.

18. The method of claim 15, wherein the generated random number is randomly generated according to the determined random number generation condition.

19. A server that generates a random number, the server comprising:
a controller that determines a random number generation condition in response to a random number generation request received from a portable terminal; and
a random number generating unit that generates the random number corresponding to the determined random number generation condition,
wherein, when a request for a significant character string is received from the portable terminal in response to an input of prefix information, the controller controls transmission of the requested significant character string to the portable terminal.

20. The server of claim 19, wherein the generated random number is formed of a prefix field and a character string field, and comprises the significant character string, a size of the significant character string, and a length of the generated random number.

21. The server of claim 20, wherein the significant character string comprises a set of at least one character that can be input based on characters having been input so far through a virtual keyboard displayed in the portable terminal.
